(19) United States
(12) Patent Application Publication
(10) Pub. No.: US 2024/0361968 A1
(43) Pub. Date: Oct. 31, 2024

(54) SCREEN PROJECTION CONTROL METHOD, DEVICE AND MEDIUM

(71) Applicant: BOE Technology Group Co., Ltd., Beijing (CN)

(72) Inventor: Xinyi CHENG, Beijing (CN)

(21) Appl. No.: 18/028,704

(22) PCT Filed: Apr. 29, 2022
(86) PCT No.: PCT/CN2022/090685

§ 371 Date: Mar. 27, 2023

(51) Int. Cl. G06F 3/14; H04L 12/12; H04L 12/18

(52) U.S. Cl. CPC G06F 3/1454; H04L 12/12; H04L 12/1845

(57) ABSTRACT

The present disclosure relates to a screen projection control method, device and medium. The method is applicable to a first electronic device, wherein the first electronic device has been paired with one or more second electronic devices, the method includes: in response to detecting a setting operation, sending a first packet to the second electronic devices that have been paired, wherein the first packet is configured to control the second electronic devices to start up in a screen-off state; and when the second electronic devices are in a start-up state, in response to receiving a screen projection instruction, sending screen projection data to the second electronic devices to enable the second electronic devices to enter a screen-on state after receiving the screen projection data and display the received screen projection data.

### CROSS REFERENCE TO RELATED APPLICATIONS

This application is the national phase of International Application No. PCT/CN2022/090685 filed on Apr. 29, 2022, the disclosure of which is hereby incorporated by reference in its entirety.

### TECHNICAL FIELD

The present disclosure relates to the field of computer technologies, and in particular to a screen projection control method, apparatus, device and medium.

### BACKGROUND

With the continuous development of Internet of Things and Internet technologies, screen projection is gradually becoming one of mainstream video viewing methods. In general, the screen projection is mainly to display content displayed on a small-screen mobile terminal on a large-screen display terminal through an interaction between the small-screen mobile terminal and the large-screen display terminal, so that the content displayed on the small-screen mobile terminal can be viewed through the large-screen display terminal.

In the related art, before the screen projection is realized through the interaction between the small-screen mobile terminal and the large-screen display terminal, it is necessary for the large-screen display terminal to be started up first, and then a connection is established between the large-screen display terminal and the small-screen mobile terminal after the large-screen display terminal is started up, so that the content displayed on the small-screen mobile terminal can be played through the large-screen display terminal.

In the above implementation process, it usually takes 10 to 30 seconds from starting up the large-screen display terminal to playing the content, resulting in the relatively low screen projection efficiency and inability to rapidly respond to screen projection requirements of a user.

### SUMMARY

The present disclosure provides a screen projection control method, apparatus, device and medium, so as to solve deficiencies in the related art.

According to a first aspect of an embodiment of the present disclosure, there is provided a screen projection control method, being applicable to a first electronic device, wherein the first electronic device has been paired with one or more second electronic devices:
the method includes:
in response to detecting a setting operation, sending a first packet to the second electronic devices that have been paired, wherein the first packet is configured to control the second electronic devices to start up in a screen-off state; and
when the second electronic devices are in a start-up state, in response to receiving a screen projection instruction, sending screen projection data to the second electronic devices to enable the second electronic devices to enter a screen-on state after receiving the screen projection data and display the received screen projection data.

According to the embodiment of the present disclosure, by in response to detecting the setting operation, sending, by the first electronic device, the first packet to the second electronic devices that have been paired to control the second electronic devices to start up in the screen-off state through the first packet, when the second electronic devices are in the start-up state, in response to receiving the screen projection instruction, the first electronic device can send screen projection data to the second electronic devices to enable the second electronic devices to directly light up the screen after receiving the screen projection data and display the screen projection data without controlling the second electronic devices to start up, thereby saving the time consumption of the process of the screen projection, improving the efficiency of the screen projection, and further improving the user experience.

In one embodiment of the present disclosure, in response to detecting the setting operation, sending the first packet to the second electronic devices that have been paired includes:
in response to detecting the setting operation, sending the first packet to a plurality of second electronic devices that have been paired and located within a setting range through broadcast.

In one embodiment of the present disclosure, the first packet at least includes a media access control (MAC) address of the plurality of second electronic devices, so that the plurality of second electronic devices perform verification based on the MAC address included in the received first packet, and perform a process of starting up in the screen-off state in response to that the MAC address passes the verification.

In one embodiment of the present disclosure, the setting operation includes at least one of:
a position of the first electronic device changes: or
an operation event of a setting type occurs in a setting application in the first electronic device.

In one embodiment of the present disclosure, the first electronic device is installed with a target application, and the second electronic devices are configured with a target function:
a process of pairing the first electronic device with the second electronic devices includes:
obtaining the MAC address of the second electronic devices configured with the target function through the target application in the first electronic device and storing the obtained MAC address, so that the first electronic device is paired with the second electronic devices.

In one embodiment of the present disclosure, after when the second electronic devices are in the start-up state, in response to receiving the screen projection instruction, sending screen projection data to the second electronic devices, the method further includes:
in response to detecting a play adjustment operation, sending a play adjustment instruction to the second electronic devices, wherein the play adjustment instruction is configured to control the second electronic devices to adjust content being played on a screen.

According to a second aspect of an embodiment of the present disclosure, there is provided a screen projection control method, being applicable to a second electronic device, wherein the second electronic device has been paired with a first electronic device:
the method includes:
in response to receiving a first packet sent by the first electronic device that has been paired, starting up in a screen-off state: and
in response to receiving screen projection data sent by the first electronic device, controlling the second electronic device to enter a screen-on state and displaying the received screen projection data on a screen.

According to the embodiment of the present disclosure, by in response to receiving a first packet sent by the first electronic device that has been paired, starting up, by the second electronic device, in a screen-off state, the second electronic device can directly light up the screen after receiving screen projection data sent by the first electronic device without controlling the second electronic devices to start up, thereby saving the time consumption of the process of the screen projection, improving the efficiency of the screen projection, and further improving the user experience.

In one embodiment of the present disclosure, the first packet at least includes a media access control (MAC) address of the second electronic device:
in response to receiving the first packet sent by the first electronic device that has been paired, starting up in the screen-off state includes:
in response to receiving the first packet, performing verification on the MAC address included in the first packet: and
in response to that the MAC address passes the verification, starting up in the screen-off state.

In one embodiment of the present disclosure, starting up in the screen-off state includes:
in the screen-off state, supplying power to a central processing unit (CPU), a logic circuit and an embedded multi media card (eMMC) of the second electronic device to enable the second electronic device to monitor the screen projection data through the CPU, the logic circuit and the eMMC.

In one embodiment of the present disclosure, the second electronic device is configured in advance to have a target function turned on:
before in response to receiving the first packet sent by the first electronic device that has been paired, starting up in the screen-off state, the method further includes:
in response to that the second electronic device has turned on the target function, receiving the first packet sent by the first electronic device through the target function.

In one embodiment of the present disclosure, before starting up in the screen-off state, the method further includes:
supplying power to a random access memory, a microcontroller unit, an Ethernet unit and a wireless overlay network unit of the second electronic device to support the second electronic device to receive the first packet sent by the first electronic device through the target function.

In one embodiment of the present disclosure, before in response to receiving the first packet sent by the first electronic device that has been paired, starting up in the screen-off state, the method further includes:
in response to a mode setting operation on the second electronic device, setting the second electronic device to a low-power screen projection mode to enable the second electronic device to start up in the screen-off state in the low-power screen projection mode.

In one embodiment of the present disclosure, the first electronic device is installed with a target application, and the second electronic device is configured with a target function:
a process of pairing the first electronic device with the second electronic device includes:
sharing the MAC address of the second electronic device with the first electronic device installed with the target application through the target function of the second electronic device, so that the first electronic device is paired with the second electronic device.

In one embodiment of the present disclosure, after in response to receiving screen projection data sent by the first electronic device, controlling the second electronic device to enter the screen-on state and displaying the received screen projection data on the screen, the method further includes:
in response to receiving a play adjustment instruction sent by the first electronic device, adjusting content being played on the screen.

According to a third aspect of an embodiment of the present disclosure, there is provided a screen projection control apparatus, being applicable to a first electronic device, wherein the first electronic device has been paired with one or more second electronic devices:
the apparatus includes:
a first sending module configured to, in response to detecting a setting operation, send a first packet to the second electronic devices that have been paired, wherein the first packet is configured to control the second electronic devices to start up in a screen-off state: and
a second sending module configured to, when the second electronic devices are in a start-up state, in response to receiving a screen projection instruction, send screen projection data to the second electronic devices to enable the second electronic devices to enter a screen-on state after receiving the screen projection data and display the received screen projection data.

In one embodiment of the present disclosure, when in response to detecting the setting operation, sending the first packet to the second electronic devices that have been paired, the first sending module is configured to:
in response to detecting the setting operation, send the first packet to a plurality of second electronic devices that have been paired and located within a setting range through broadcast.

In one embodiment of the present disclosure, the first packet at least includes a media access control (MAC) address of the plurality of second electronic devices, so that the plurality of second electronic devices perform verification based on the MAC address included in the received first packet, and perform a process of starting up in the screen-off state in response to that the MAC address passes the verification.

In one embodiment of the present disclosure, the setting operation includes at least one of:
a position of the first electronic device changes: or
an operation event of a setting type occurs in a setting application in the first electronic device.

In one embodiment of the present disclosure, the first electronic device is installed with a target application, and the second electronic devices are configured with a target function:
the apparatus further includes:
a pairing module configured to obtain the MAC address of the second electronic devices configured with the target function through the target application in the first electronic device and store the obtained MAC address, so that the first electronic device is paired with the second electronic devices.

In one embodiment of the present disclosure, the apparatus further includes:
a third sending module configured to, in response to detecting a play adjustment operation, send a play adjustment instruction to the second electronic devices, wherein the play adjustment instruction is configured to control the second electronic devices to adjust content being played on a screen.

According to a fourth aspect of an embodiment of the present disclosure, there is provided a screen projection control apparatus, being applicable to a second electronic device, wherein the second electronic device has been paired with a first electronic device:
the apparatus includes:
a start-up module configured to, in response to receiving a first packet sent by the first electronic device that has been paired, start up in a screen-off state: and
a display module configured to, in response to receiving screen projection data sent by the first electronic device, control the second electronic device to enter a screen-on state and display the received screen projection data on a screen.

In one embodiment of the present disclosure, the first packet at least includes a media access control (MAC) address of the second electronic device:
when in response to receiving the first packet sent by the first electronic device that has been paired, starting up in the screen-off state, the start-up module is configured to:
in response to receiving the first packet, perform verification on the MAC address included in the first packet: and
in response to that the MAC address passes the verification, start up in the screen-off state.

In one embodiment of the present disclosure, when starting up in the screen-off state, the start-up module is configured to:
in the screen-off state, supplying power to a central processing unit (CPU), a logic circuit and an embedded multi media card (eMMC) of the second electronic device to enable the second electronic device to monitor the screen projection data through the CPU, the logic circuit and the eMMC.

In one embodiment of the present disclosure, the second electronic device is configured in advance to have a target function turned on:
the apparatus further includes:
a receiving module configured to, in response to that the second electronic device has turned on the target function, receive the first packet sent by the first electronic device through the target function.

In one embodiment of the present disclosure, the apparatus further includes:
a power supply module configured to supply power to a random access memory, a microcontroller unit, an Ethernet unit and a wireless overlay network unit of the second electronic device to support the second electronic device to receive the first packet sent by the first electronic device through the target function.

In one embodiment of the present disclosure, the apparatus further includes:
a setting module configured to, in response to a mode setting operation on the second electronic device, set the second electronic device to a low-power screen projection mode to enable the second electronic device to start up in the screen-off state in the low-power screen projection mode.

In one embodiment of the present disclosure, the first electronic device is installed with a target application, and the second electronic device is configured with a target function:
the apparatus further includes:
a pairing module configured to share the MAC address of the second electronic device with the first electronic device installed with the target application through the target function of the second electronic device, so that the first electronic device is paired with the second electronic device.

In one embodiment of the present disclosure, the apparatus further includes:
an adjustment module configured to, in response to receiving a play adjustment instruction sent by the first electronic device, adjust content being played on the screen.

According to a fifth aspect of an embodiment of the present disclosure, there is provided an electronic device including a memory, a processor and a computer program stored in the memory and executable by the processor the processor, wherein, when the computer program is executed by the processor, the processor is configured to implement the operations performed by the screen projection control method according to the first aspect and any one of the embodiments of the first aspect.

According to a sixth aspect of an embodiment of the present disclosure, there is provided an electronic device including a memory, a processor and a computer program stored in the memory and executable by the processor the processor, wherein, when the computer program is executed by the processor, the processor is configured to implement the operations performed by the screen projection control method according to the second aspect and any one of the embodiments of the second aspect.

According to a seventh aspect of an embodiment of the present disclosure, there is provided a computer readable storage medium storing a program thereon, wherein, when the program is executed by a processor, the processor is configured to implement the operations performed by the screen projection control method according to the first aspect and any one of the embodiments of the first aspect.

According to an eighth aspect of an embodiment of the present disclosure, there is provided a computer readable storage medium storing a program thereon, wherein, when the program is executed by a processor, the processor is configured to implement the operations performed by the screen projection control method according to the second aspect and any one of the embodiments of the second aspect.

According to a ninth aspect of an embodiment of the present disclosure, there is provided a computer program product, including a computer program, when the computer program is executed by a processor, the processor is configured to implement the operations performed by the screen projection control method according to the first aspect and any one of the embodiments of the first aspect.

According to a tenth aspect of an embodiment of the present disclosure, there is provided a computer program product, including a computer program, when the computer program is executed by a processor, the processor is configured to implement the operations performed by the screen projection control method according to the second aspect and any one of the embodiments of the second aspect.

It should be understood that the above general descriptions and subsequent detailed descriptions are merely illustrative and explanatory, and shall not constitute limitation to the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a schematic diagram of an implementation environment illustrating a screen projection control method according to an embodiment of the present disclosure.

FIG. 2 is a flowchart illustrating a screen projection control method according to an embodiment of the present disclosure.

FIG. 3 is a setting interface diagram illustrating a target function according to an embodiment of the present disclosure.

FIG. 4 is a flowchart illustrating a second electronic device is set to turn on a target function according to an embodiment of the present disclosure.

FIG. 5 is a block diagram illustrating a second electronic device according to an embodiment of the present disclosure.

FIG. 6 is a flowchart illustrating a first electronic device binding and waking up a second electronic device according to an embodiment of the present disclosure.

FIG. 7 is a schematic interface diagram illustrating a mode setting interface according to an embodiment of the present disclosure.

FIG. 8 is a flowchart illustrating a process in which a first electronic device wakes up a second electronic device and performs screen projection according to an embodiment of the present disclosure.

FIG. 9 is an interactive flowchart illustrating a screen projection control process between a first electronic device and a second electronic device according to an embodiment of the present disclosure.

FIG. 10 is an enabling flowchart illustrating a low-power screen projection mode according to an embodiment of the present disclosure.

FIG. 11 is a block diagram illustrating a screen projection control apparatus according to an embodiment of the present disclosure.

FIG. 12 is a block diagram illustrating a screen projection control apparatus according to an embodiment of the present disclosure.

FIG. 13 is a schematic structural diagram illustrating an electronic device according to an embodiment of the present disclosure.

FIG. 14 is a schematic structural diagram illustrating an electronic device according to an embodiment of the present disclosure.

### DETAILED DESCRIPTION OF THE EMBODIMENTS

Exemplary embodiments will be described in detail here, examples of which are illustrated in the accompanying drawings. When the following description refers to the drawings, unless otherwise indicated, the same numerals in different drawings indicate the same or similar elements. The implementations set forth in the following description of exemplary embodiments do not represent all implementations consistent with the embodiments of the present disclosure. Instead, they are merely examples of apparatuses and methods consistent with aspects related to the embodiments of the present disclosure as recited in the appended claims.

A screen projection control method provided by the present disclosure is used for displaying content on a screen of a first electronic device on a screen of a second electronic device, so as to realize screen projection between the first electronic device and the second electronic device. Referring to FIG. 1, FIG. 1 is a schematic diagram of an implementation environment illustrating a screen projection control method according to an embodiment of the present disclosure. As shown in FIG. 1, the implementation environment can include a first electronic device 101 and a second electronic device 102.

The first electronic device 101 can be a small-screen electronic device such as a smart phone and a tablet computer, and the second electronic device 102 can be a large-screen display device such as a large-screen display, a projector screen, an intelligent all-in-one computer. The present disclosure does not limit device types of the first electronic device 101 and the second electronic device 102.

It should be noted that the screen of the second electronic device can be a liquid crystal display (LCD) screen, or the screen of the second electronic device can be an organic light-emitting diode (OLED) screen, optionally, the screen of the second electronic device can also be other types of screens, and the present disclosure is not limited to this.

Optionally, the first electronic device 101 and the second electronic device 102 can communicate in a manner of wired or wireless connection, and the present disclosure is not limited to which manner is specifically adopted.

In one possible implementation, the first electronic device 101 and the second electronic device 102 can be paired (or bound) in advance, so that the screen projection between the first electronic device 101 and the second electronic device 102 can by realized through the screen projection control method provided by the present disclosure.

The above is only an exemplary introduction about the implementation environment of the present disclosure. In more possible implementations, the screen projection control method provided by the present disclosure can also be applied to various implementation environments involving a process of the screen projection, and the present disclosure does not limit the specific implementation environment.

After introducing the implementation environment of the present disclosure, the screen projection control method provided by the present disclosure will be described in detail.

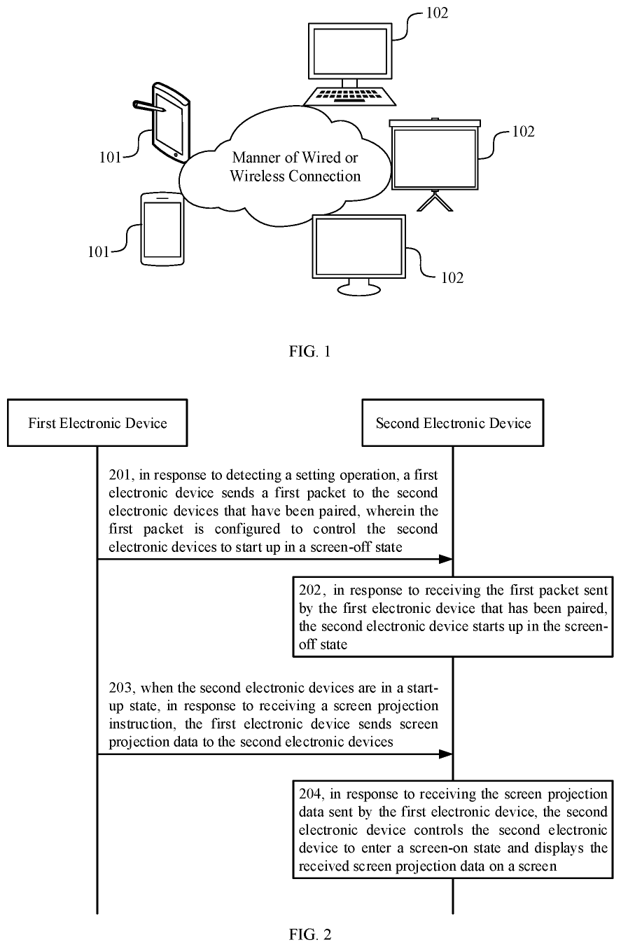

Referring to FIG. 2, FIG. 2 is a flowchart illustrating a screen projection control method according to an embodiment of the present disclosure. The method can include the following steps.

Step 201, in response to detecting a setting operation, a first electronic device sends a first packet to the second electronic devices that have been paired, wherein the first packet is configured to control the second electronic devices to start up in a screen-off state.

The first electronic device and the second electronic device may be paired in advance. Optionally, the first electronic device may be paired with a plurality of second electronic devices in advance. The first packet can also be called a wake up packet (WUP), a magic packet, and the like.

It should be noted that the screen-off state is a state in which the second electronic device is powered on, but a screen thereof in an off state. Taking the screen of the second electronic device as an LCD screen as an example, the screen-off state can be to turn off a backlight system of the second electronic device. Taking the screen of the second electronic device as an OLED screen as an example, the screen-off state can be that the OLED display of the second electronic device is turned off.

Step 202, in response to receiving the first packet sent by the first electronic device that has been paired, the second electronic device starts up in the screen-off state.

Step 203, when the second electronic devices are in a start-up state, in response to receiving a screen projection instruction, the first electronic device sends screen projection data to the second electronic devices.

Step 204, in response to receiving the screen projection data sent by the first electronic device, the second electronic device controls the second electronic device to enter a screen-on state and displays the received screen projection data on a screen.

According to the embodiment of the present disclosure, by in response to detecting the setting operation, sending, by the first electronic device, the first packet to the second electronic device that has been paired to enable the second electronic device to start up in the screen-off state after receiving the first packet: when the second electronic device is in the start-up state, in response to receiving the screen projection instruction, the first electronic device can send screen projection data to the second electronic device to enable the second electronic device to directly light up the screen after receiving the screen projection data and display the screen projection data without controlling the second electronic devices to start up, thereby saving the time consumption of the process of the screen projection, improving the efficiency of the screen projection, and further improving the user experience.

After introducing the basic implementation process of the present disclosure, various non-limiting embodiments of the present disclosure are described below.

In some embodiments, the first electronic device and the second electronic device may be paired in advance. Optionally, the first electronic device can be installed with a target application, and the second electronic device can be configured with a target function, therefore, the first electronic device can be paired with the second electronic device through the target application installed in the first electronic device and the target function configured in the second electronic device.

The target application can be an application supporting wake on lan (WOL), for example, the target application can be an application supporting wake on wlan. Optionally, the target application can also be an application supporting other wake on lan methods, and the present disclosure is not limited to which manner is specifically adopted to realize wake on lan. In one possible implementation, the target application can be a magic packet, and the first electronic device can download the target application through a browser, an application market, and the like.

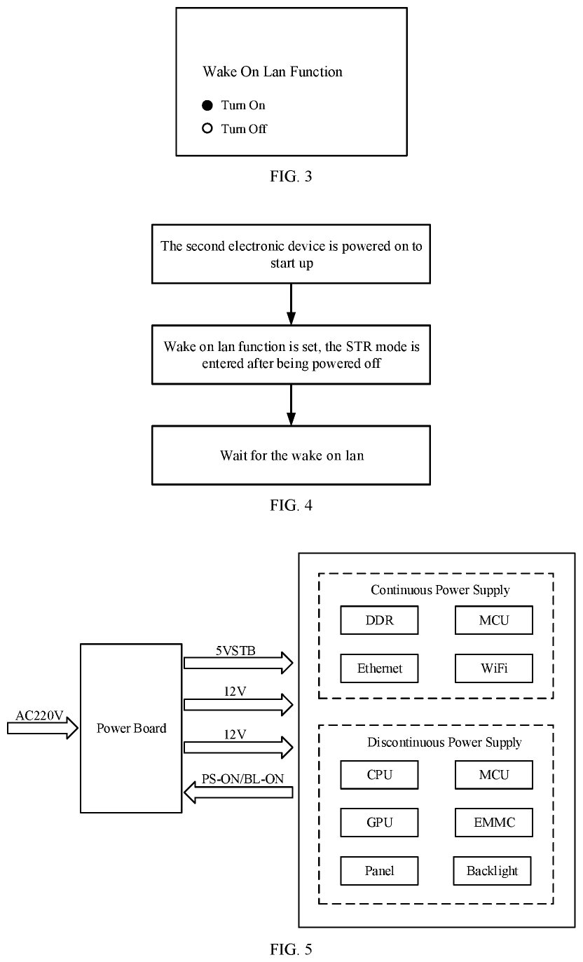

The target function can be a wake on lan function, for example, a WOL function, and the second electronic device can be configured to support the target function at the factory, so that the second electronic device can realize a remote wake up through the target function when the target function is turned on and the second electronic device is powered on but not started up. Optionally, a user can also turn off the target function of the second electronic device by himself/herself. Referring to FIG. 3, FIG. 3 is a setting interface diagram illustrating a target function according to an embodiment of the present disclosure. The user can turn off the target function of the second electronic device through the setting interface shown in FIG. 3. For example, the user can trigger a closing control shown in FIG. 3, and the second electronic device can turn off the target function of the second electronic device itself in response to a trigger operation of the closing control.

Further, when the target function is turned off, the user can turn on the target function of the second electronic device again through the setting interface shown in FIG. 3. For example, the user can trigger an opening control shown in FIG. 3, and the second electronic device can turn on the target function of the second electronic device itself in response to a trigger operation of the opening control. It should be noted that by setting the second electronic device to turn on the target function, the second electronic device can enter a STR mode after being powered off, and then wait for a remote wake up initiated by other devices through wired or wireless networks in the STR mode. In the STR mode, the second electronic device can store startup data in a random access memory (RAM), so as to quickly start up the second electronic device.

A flowchart described in the above process can be seen in FIG. 4. FIG. 4 is a flowchart illustrating a second electronic device is set to turn on a target function according to an embodiment of the present disclosure. As shown in FIG. 4, after the second electronic device is powered on to start up, the second electronic device can be set to turn on the target function through the setting interface shown in FIG. 3, so that the second electronic device can enter the STR mode after being powered off, and wait for the wake on lan in the STR mode. The target function can be a wake on lan function (WOL function).

In one possible implementation, the first electronic device can be paired with the second electronic device through the following method:
obtaining a medium/media access control (MAC) address of the second electronic devices configured with the target function through the target application in the first electronic device and storing the obtained MAC address, so that the first electronic device is paired with the second electronic devices.

That is, the second electronic device can send the MAC address of the second electronic device to the first electronic device through the target function, so that the first electronic device can obtain the MAC address of the second electronic device through the installed target application. Optionally, the first electronic device can store the MAC address of the second electronic device, so that the first electronic device and the second electronic device can share the MAC address of the second electronic device.

In addition, in the case that the first electronic device and the second electronic device share the MAC address of the second electronic device, the first electronic device and the second electronic device can also share a preset password, so that the first electronic device can be paired with the second electronic device under the condition of sharing the MAC address and the preset password of the second electronic device.

In a process that the first electronic device and the second electronic device share the preset password, the second electronic device can randomly generate a preset password and store the generated preset password: further, the second electronic device can send the generated preset password to the first electronic device, and the first electronic device can store the received preset password when receiving the preset password sent by the second electronic device, so that the first electronic device and the second electronic device can share the preset password. Optionally, the preset password can also be generated by the first electronic device and sent to the second electronic device by the first electronic device, which is not limited by the present disclosure.

Optionally, the preset password can be a random combination of a series of numbers, letters or symbols, or the preset password can be a combination of any two or three types of characters among numbers, letters and symbols, and the present disclosure does not limit the specific character types included in the preset password. The preset password can be 4 or 6 digits. In more possible implementations, a number of digits of the preset password can be more or less, and the present disclosure does not limit the number of digits of the preset password.

By sharing the MAC address of the second electronic device, or sharing the MAC address and password of the second electronic device with the first electronic device, the first electronic device can be paired with the second electronic device, so that the first electronic device can directly send the first packet to the paired second electronic device.

Optionally, a first electronic device can be paired with a plurality of second electronic devices, and a second electronic device can also be paired with a plurality of first electronic devices, which is not limited by the present disclosure. The above description only takes a process of pairing a first electronic device with a second electronic device as an example, and a process of pairing the first electronic device with the second electronic device with different device types can be the same as the above process, which will not be repeated here.

After the first electronic device is paired with the second electronic device through the above process, the first electronic device can send the first packet to the paired second electronic device through step 201 when the setting operation is detected.

In some embodiments, for step 201, in response to detecting the setting operation, sending the first packet to the second electronic devices that have been paired can be realized through the following step:
in response to detecting the setting operation, sending the first packet to a plurality of second electronic devices that have been paired and located within a setting range through broadcast.

It should be noted that since the first electronic device can be paired with the plurality of second electronic devices, the first electronic device can send the first packet to the plurality of second electronic devices located within the setting range when the setting operation is detected, and the first packet can be sent to the plurality of second electronic devices at the same time through the broadcast.

The setting operation can be that a position of the first electronic device changes, for example, the first electronic device is picked up: or, the setting operation can also be an operation event of a setting type occurs in a setting application in the first electronic device, wherein the setting application can be a multimedia application, for example, a video playing application, and the operation event of the setting type can be that the setting application is opened. Optionally, the setting operation can also be other types of operations, and the present disclosure does not limit the specific type of the setting operation.

Optionally, the setting range can be a circular range with a location of the first electronic device as a center and a setting distance as a radius, or the setting range can be of other types, which is not limited by the present disclosure.

It should be noted that when the first electronic device sends the first packet to the plurality of second electronic devices through the broadcast, not all the second electronic devices that have been paired with the first electronic device and are powered on but not started up can receive the first packet. In one possible implementation, only a plurality of second electronic devices that have been configured to turn on the target function in advance can receive the first packet sent by the first electronic device, that is, it is necessary for respective second electronic devices to receive the first packet through the target function; in other words, the second electronic devices can only receive the first packet sent by the first electronic device through the target function when the target function is turned on.

In one possible implementation, the second electronic device can supply power to a random access memory (RAM), a micro control unit (MCU), an Ethernet unit and a wireless overlay network unit of the second electronic device when a power supply is turned on, so as to support the second electronic device to receive the first packet sent by the first electronic device through the target function.

The random access memory can be a synchronous dynamic random access memory (SDRAM), for example, a double data rate synchronous dynamic random access memory (DDR SDRAM, referred to as DDR). Optionally, the random access memory can be of other types, which is not limited by the present disclosure. The wireless overlay network unit can be a WiFi unit, and optionally, the wireless overlay network unit can be of other types, which is not limited by the present disclosure.

The above random access memory, the micro control unit, the Ethernet unit and the wireless overlay network unit can be used as continuous power supply parts of the second electronic device, when the second electronic device is powered on, these parts can be powered on to support the target function through these parts, so that the second electronic device can receive the first packet through the target function. Optionally, the second electronic device can receive the first packet through a physical layer (PHY) device, for example, the first packet can be received through a network card.

It should be noted that a purpose of setting the continuous power supply parts is to ensure that the second electronic device can be awakened by functions of a remote controller such as an infrared (IR), a key press and a WOL in a standby state, so that the second electronic device can enter a normal working state.

Referring to FIG. 5, FIG. 5 is a block diagram illustrating a second electronic device according to an embodiment of the present disclosure. In FIG. 5, taking the random access memory as the DDR and the wireless overlay network unit as the WiFi unit as an example. As shown in FIG. 5, the second electronic device can be powered by 220V alternating current (AC 220V). When a power board of the second electronic device receives an input of 220v alternating current, the 220V alternating current can be converted into 5V direct current (that is, DC 5VSTB), 12V direct current (DC 12V), backlight constant current output (PS-ON) and backlight constant current enable (BL-ON) supplied by a central processing unit (CPU) system, so that power is supplied to the DDR, the MCU, the Ethernet and the WiFi as the continuous power supply parts through an output obtained through a transfer when the second electronic device is turned off, so that the second electronic device can receive the first packet sent by the first electronic device when the second electronic device is turned off. Optionally, the DDR, the Ethernet and the WiFi can be set to cancel continuous power supply or reset to the continuous power supply through software.

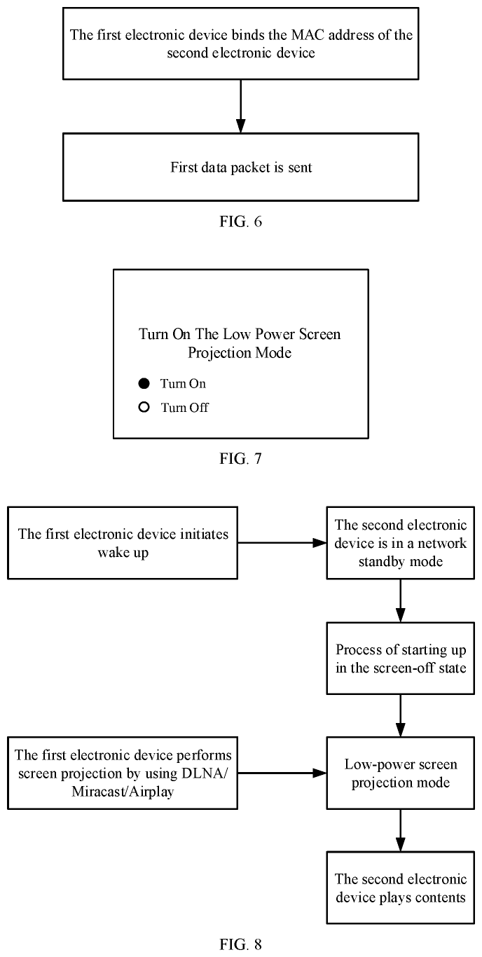

The above process of pairing the first electronic device with the second electronic device and then waking up the second electronic device through the first electronic device can be seen in FIG. 6. FIG. 6 is a flowchart illustrating a first electronic device binding and waking up a second electronic device according to an embodiment of the present disclosure. As shown in FIG. 6, the first electronic device can bind the MAC address of the second electronic device to realize a binding of the first electronic device and the second electronic device, so that the first electronic device can send the first packet to the paired (or bound) second electronic device to wake up the second electronic device.

It should be noted that since the first electronic device sends the first packet by broadcast, that is, a plurality of second electronic devices can receive the first packet sent by the first electronic device, in this case, a verification method can be provided, so that the second electronic device can determine whether the received first packet is to be sent to itself, and then communication between the first electronic device and a specific second electronic device can be realized.

The first packet can include the MAC address of the second electronic device, so that a plurality of second electronic devices can perform verification on the MAC address included in the received first packet to determine whether the received first packet is to be sent to themselves. In this case, a packet format of the first packet can be FF FF FF FF FF FF plus the MAC address (repeated 16 times).

Optionally, on the premise that the first packet includes the MAC address of the second electronic device, the first packet can also include a preset password, so that the plurality of second electronic devices can perform the verification on the MAC address and the preset password included in the received first packet to determine whether the received first packet is to be sent to themselves. In this case, a packet format of the first packet can be FF FF FF FF FF FF plus the MAC address (repeated 16 times) plus the preset password.

In some embodiments, for step 202, in response to receiving the first packet sent by the first electronic device that has been paired, starting up in the screen-off state can include the following steps.

Step 2021, in response to receiving the first packet, the second electronic device performs verification on the MAC address included in the first packet.

When the first packet includes the MAC address of the second electronic device, in response to receiving the first packet. the second electronic device can compare the MAC address of the second electronic device included in the received first packet with the MAC address of the second electronic device itself to perform verification on the first packet.

When the first packet includes the MAC address of the second electronic device and the preset password. in response to receiving the first packet, the second electronic device can compare the MAC address of the second electronic device included in the received first packet with the MAC address of the second electronic device itself, and compare the preset password included in the received first packet with the stored preset password of the second electronic device itself to perform verification on the first packet.

Step 2022, in response to that the MAC address passes the verification, the second electronic device starts up in the screen-off state.

In the case that the first packet includes the MAC address of the second electronic device, if the MAC address of the second electronic device included in the first packet is consistent with the MAC address of the second electronic device itself, the second electronic device can determine that the first packet has passed the verification, and the second electronic device can start up in the screen-off state in response to passing the verification.

The above process is described by taking that the first packet only includes the MAC address of the second electronic device as an example. however, the first packet can also include the preset password. When the first packet includes the MAC address of the second electronic device and the preset password, for step 2021, the second electronic device can perform verification on the MAC address and the preset password while performing verification on the first packet. In one possible implementation, the second electronic device can compare the MAC address of the second electronic device included in the received first packet with the MAC address of the second electronic device itself, and compare the preset password included in the received first packet with the stored preset password of the second electronic device itself to perform verification on the first packet.

Based on this, for step 2022, if the MAC address of the second electronic device included in the first packet is consistent with the MAC address of the second electronic device itself, and the preset password included in the received first packet is consistent with the stored preset password of the second electronic device itself, the second electronic device can determine that the first packet has passed the verification, and the second electronic device can start up in the screen-off state in response to passing the verification.

In some embodiments, the second electronic device starts up in the screen-off state can be realized through the following step:
in the screen-off state, supplying power to a central processing unit (CPU), a logic circuit and an embedded multi media card (eMMC) of the second electronic device to enable the second electronic device to monitor the screen projection data through the CPU, the logic circuit and the eMMC.

Taking the second electronic device shown in FIG. 5 as an example, in response to that the received first packet has passed the verification, the second electronic device can supply power to the CPU, the logic circuit and the eMMC that are used as discontinuous power supply parts (that is, power-off parts) through an output obtained through a transfer performed by the power board, so that the second electronic device can monitor the screen projection data through the CPU, the logic circuit and the eMMC.

The above process is described by taking that the second electronic device starts up in the screen-off state after receiving the first packet as an example. It should be noted that the second electronic device can be set to a low-power screen projection mode in advance, so that the second electronic device can start up in the screen-off state in the low-power screen projection mode after receiving the first packet.

In one possible implementation, the user can perform a mode setting operation on the second electronic device, and the second electronic device can set the second electronic device to the low-power screen projection mode in response to the mode setting operation on the second electronic device, so that the second electronic device can start up in the screen-off state in the low-power screen projection mode.

For example, the second electronic device can display a mode setting function entry on a visual interface of the second electronic device, and the user can trigger the mode setting function entry, and in response to a trigger operation of the mode setting function entry, the second electronic device can display a mode setting interface to perform the mode setting operation in the mode setting interface.

Referring to FIG. 7, FIG. 7 is a schematic interface diagram illustrating a mode setting interface according to an embodiment of the present disclosure. The second electronic device can display the mode setting interface shown in FIG. 7 on the visual interface of the second electronic device. The mode setting interface shown in FIG. 7 can include an opening control and a closing control, so that the user can set the second electronic device to support the low-power screen projection mode by triggering the opening control. In addition, the user can set the second electronic device to not support the low-power screen projection mode by triggering the closing control.

It should be noted that the user can set the low-power screen projection mode at any time. For example, the user can set the second electronic device to the low-power screen projection mode before the second electronic device is turned off, or the user can set the second electronic device to the low-power screen projection mode after the second electronic device is turned on, for example, the second electronic device can be set to the low-power screen projection mode at any time in an use process after the second electronic device is turned on, and the present disclosure does not limit the specific time when the second electronic device is set to the low-power screen projection mode.

In a formal mode, the second electronic device should normally enter a desktop, a system interface, an Android desktop launcher page, or the like. When the second electronic device is set to the low-power screen projection mode, a system can be started up in response to turning off a backlight, that is, system can be started up in the screen-off state, so that unnecessary functions such as the backlight can be turned off to save energy consumption of the second electronic device. In addition, the user can also exit the low-power screen projection mode or turn the second electronic device off through a remote controller, thereby improving the flexibility of a process of controlling the screen projection.

Optionally, after starting up in the screen-off state, the second electronic device can send feedback information to the first electronic device, wherein the feedback information is used to indicate that the second electronic device has been started up in the screen-off state, so that the first electronic device can determine that the second electronic device has been started up in the screen-off state after receiving the feedback information, and subsequent processes of the screen projection can be carried out.

Based on this, for step 203, when the second electronic devices are in the start-up state, in response to receiving the screen projection instruction, sending, by the first electronic device, the screen projection data to the second electronic devices can be realized through the following step:
in response to receiving the feedback information from the second electronic device, determining, by the first electronic device, that the second electronic device has been in the start-up state, so that the first electronic device can send the screen projection data to the second electronic device in response to receiving the screen projection instruction.

The screen projection instruction can be triggered by the user in a specific application developed by the screen projection control method provided by the present disclosure. The specific application can be dedicated to providing a screen projection function, or the specific application can be associated with other applications in the first electronic device, so that the user can trigger screen projection of pages of other applications associated with the specific application through the specific application. Other applications associated with the specific application can be various types of applications, for example, video play applications.

In addition, the screen projection instruction can also be triggered by the user in an application supporting the screen projection function, for example, the video play applications supporting the screen projection function. In one possible implementation, a display page of the application supporting the screen projection function can include a screen projection control, and the user can trigger the screen projection control to trigger the screen projection of the page of the application supporting the screen projection function.

The above are only two exemplary methods to trigger the screen projection instruction. In more possible implementations, the screen projection instruction can be triggered by other methods, and the present disclosure does not limit the specific trigger mode of the screen projection instruction.

The screen projection data can be video data, image data, text data, and the like. The present disclosure does not limit the specific data type of the screen projection data.

It should be noted that after the first electronic device sends the screen projection data to the second electronic device in step 203, the second electronic device can light up the screen in step 204 to display the received screen projection data.

Taking the second electronic device shown in FIG. 5 as an example, the second electronic device can supply power to a graphics processing unit (GPU), a panel and a backlight unit that are used as discontinuous power supply parts (that is, power-off parts) through the output obtained through the transfer performed by the power board, so that the second electronic device can light up the screen through the backlight unit, and display the screen projection data through the GPU and the panel.

Optionally, the transmission and reception of the screen projection data between the first electronic device and the second electronic device can be realized by means of digital living network alliance (DLNA) technologies, wireless authentication (Miracast) technologies or airplay technologies. The present disclosure does not limit which method is specifically adopted.

It should be noted that the processes described in the above respective embodiments can be seen in FIG. 8. FIG. 8 is a flowchart illustrating a process in which a first electronic device wakes up a second electronic device and performs screen projection according to an embodiment of the present disclosure. As shown in FIG. 8, when the second electronic device is in a network standby mode, the first electronic device can initiate a wake up to the second electronic device, and the second electronic device can perform the process of starting up in the screen-off state to monitor the screen projection data sent by the first electronic device through the methods such as the DLNA, the Miracast and the Airplay in the low-power screen projection mode, so as to play corresponding content based on the received screen projection data.

In some embodiments, after the screen projection between the first electronic device and the second electronic device is realized through the above steps 201 to 204, the content being played in the screen of the second electronic device can also be adjusted through the first electronic device.

That is, after step 204, the method can further include the following steps.

Step 205, in response to detecting a play adjustment operation, the first electronic device sends a play adjustment instruction to the second electronic devices, wherein the play adjustment instruction is configured to control the second electronic devices to adjust content being played on a screen.

The play adjustment operation can include a pause operation, a fast forward operation, a fast backward operation, a double-speed play operation, an exit operation, and the like. The play adjustment operation can be triggered by the user in the first electronic device. For example, different controls can be set for different types of play adjustment operations in a visual interface of the first electronic device, and the user can trigger the corresponding types of play adjustment operations by triggering the corresponding controls. For example, the user can trigger the pause operation by triggering a pause control, and for example, the user can trigger the fast forward operation by triggering a fast forward control, and the like.

The first electronic device can generate a play adjustment instruction when detecting the play adjustment operation, and then send the play adjustment instruction to the second electronic device.

It should be noted that since the play adjustment operation can include various types of operations, the play adjustment instruction generated based on the play adjustment operation can also adjust different types of contents being played. For example, the play adjustment instruction generated based on the pause operation can be used to control the second electronic device to pause the content being played on the screen, and for example, the play adjustment instruction generated based on the fast forward operation can be used to control the second electronic device to fast forward the content being played on the screen.

Step 206, in response to receiving a play adjustment instruction sent by the first electronic device, the second electronic device adjusts content being played on the screen.

It should be noted that after receiving the play adjustment instruction, the second electronic device can make a corresponding adjustment to the content being played on the screen based on the received play adjustment instruction, including but not limited to, pause, fast forward, fast backward, double-speed play, exit, and the like.

Optionally, when performing the play adjustment of the screen projection data between the first electronic device and the second electronic device, it can also be realized by means of the DLNA technologies, the Miracast technologies or the Airplay technologies, and the like, and the present disclosure does not limit which method is specifically adopted.

The above embodiment provides a way to control the second electronic device to adjust the content played by the second electronic device through the first electronic device after screen projection, so that the user can adjust the content played by the second electronic device without operating on the second electronic device, thereby improving the flexibility of a process of controlling the screen projection.

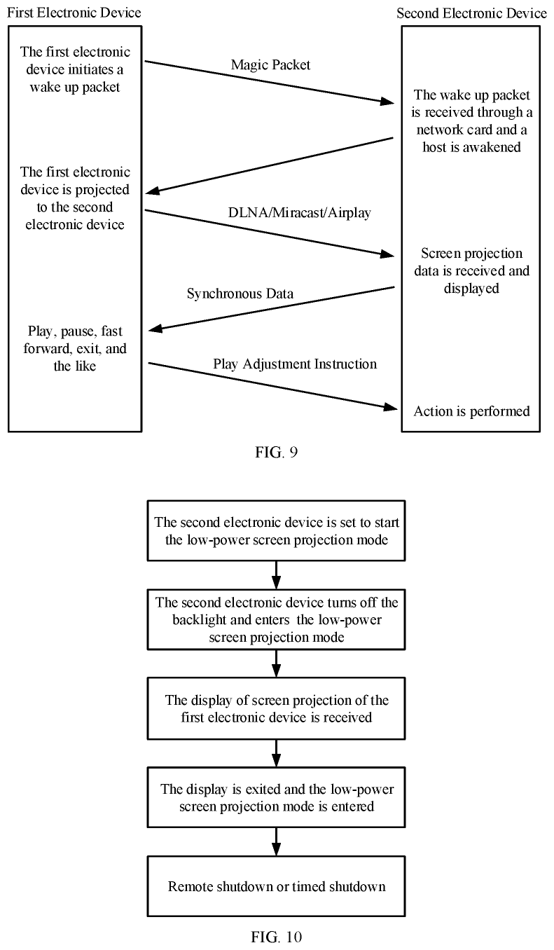

It should be noted that the processes described in the above respective embodiments can be seen in FIG. 9. FIG. 9 is an interactive flowchart illustrating a screen projection control process between a first electronic device and a second electronic device according to an embodiment of the present disclosure. As shown in FIG. 9, the first electronic device can send a wake up packet to the second electronic device, and the second electronic device can receive the wake up packet through a network card and start up in a screen-off state to wake up a host. The first electronic device can send screen projection data to the second electronic device by means of the DLNA, Miracast and Airplay when the second electronic device is in a start-up state, that is, the host of the second electronic device is awakened, and the second electronic device can receive and display the screen projection data. Further, the user can also perform operations such as play, pause, fast forward and exit on the first electronic device to trigger corresponding play adjustment instructions, so that the second electronic device can perform corresponding actions based on the received play adjustment instructions to adjust the content being played by the second electronic device.

In more possible implementations, in a process that the second electronic device displays the received screen projection data, the user can control the second electronic device to turn off by remote control. In addition, after finishing playing the screen projection data sent by the first electronic device, the second electronic device exits the display and enters the low-power screen projection mode again, that is, the screen will wait for the first electronic device to project again. Optionally, the second electronic device can also be automatically turned off after a period of inactivity.

It should be noted that the processes described in the above respective embodiments can be seen in FIG. 10. FIG. 10 is an enabling flowchart illustrating a low-power screen projection mode according to an embodiment of the present disclosure. As shown in FIG. 10, when the second electronic device is set to start the low-power screen projection mode, the second electronic device can complete a start-up process in the screen-off state, that is, the second electronic device can turn off the backlight when starting up and enter the low-power screen projection mode, so as to receive the screen projection data of the first electronic device in the low-power screen projection mode, and then display the received screen projection data. After finishing playing the screen projection data sent by the first electronic device, the second electronic device can exit the display and enter the low-power screen projection mode again. At this time, the user can control the second electronic device to turn off by remote control, or the second electronic device can be automatically turned off after a period of inactivity.

By waiting for the screen projection of the first electronic device after the screen projection data sent by the first electronic device is played, the power consumption of the second electronic device can be effectively reduced, thereby improving the service life of the second electronic device.

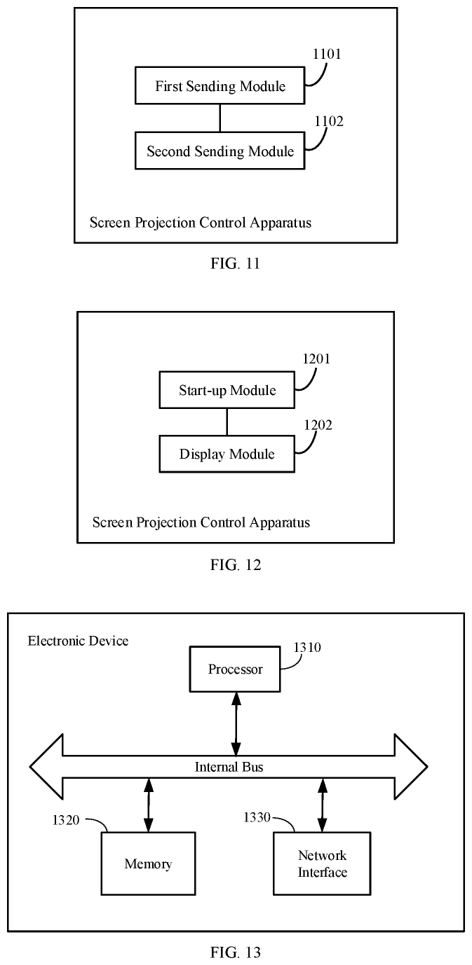

An embodiment of the present disclosure also provides a screen projection control apparatus. As shown in FIG. 11, FIG. 11 is a block diagram illustrating a screen projection control apparatus according to an embodiment of the present disclosure. The screen projection control apparatus is applied to a first electronic device, and the first electronic device has been paired with one or more second electronic devices. As shown in FIG. 11, the apparatus includes:
a first sending module 1101 configured to, in response to detecting a setting operation, send a first packet to the second electronic devices that have been paired, wherein the first packet is configured to control the second electronic devices to start up in a screen-off state; and
a second sending module 1102 configured to, when the second electronic devices are in a start-up state, in response to receiving a screen projection instruction, send screen projection data to the second electronic devices to enable the second electronic devices to enter a screen-on state after receiving the screen projection data and display the received screen projection data.

In one embodiment of the present disclosure, when in response to detecting the setting operation, sending the first packet to the second electronic devices that have been paired, the first sending module 1101 is configured to:
in response to detecting the setting operation, send the first packet to a plurality of second electronic devices that have been paired and located within a setting range through broadcast.

In one embodiment of the present disclosure, the first packet at least includes a media access control (MAC) address of the plurality of second electronic devices, so that the plurality of second electronic devices perform verification based on the MAC address included in the received first packet, and perform a process of starting up in the screen-off state in response to that the MAC address passes the verification.

In one embodiment of the present disclosure, the setting operation includes at least one of:
a position of the first electronic device changes; or
an operation event of a setting type occurs in a setting application in the first electronic device.

In one embodiment of the present disclosure, the first electronic device is installed with a target application, and the second electronic devices are configured with a target function;
the apparatus further includes:
a pairing module configured to obtain the MAC address of the second electronic devices configured with the target function through the target application in the first electronic device and store the obtained MAC address, so that the first electronic device is paired with the second electronic devices.

In one embodiment of the present disclosure, the apparatus further includes:
a third sending module configured to, in response to detecting a play adjustment operation, send a play adjustment instruction to the second electronic devices, wherein the play adjustment instruction is configured to control the second electronic devices to adjust content being played on a screen.

An embodiment of the present disclosure also provides another screen projection control apparatus. As shown in FIG. 12, FIG. 12 is a block diagram illustrating a screen projection control apparatus according to an embodiment of the present disclosure. The screen projection control apparatus is applied to a second electronic device, and the second electronic device has been paired with a first electronic device. As shown in FIG. 12, the apparatus includes:
a start-up module 1201 configured to, in response to receiving a first packet sent by the first electronic device that has been paired, start up in a screen-off state; and
a display module 1202 configured to, in response to receiving screen projection data sent by the first electronic device, control the second electronic device to enter a screen-on state and display the received screen projection data on a screen.

In one embodiment of the present disclosure, the first packet at least includes a media access control (MAC) address of the second electronic device;
when in response to receiving the first packet sent by the first electronic device that has been paired, starting up in the screen-off state, the start-up module 1201 is configured to:
in response to receiving the first packet, perform verification on the MAC address included in the first packet; and
in response to that the MAC address passes the verification, start up in the screen-off state.

In one embodiment of the present disclosure, when starting up in the screen-off state, the start-up module 1201 is configured to:
in the screen-off state, supplying power to a central processing unit (CPU), a logic circuit and an embedded multi media card (eMMC) of the second electronic device to enable the second electronic device to monitor the screen projection data through the CPU, the logic circuit and the eMMC.

In one embodiment of the present disclosure, the second electronic device is configured in advance to have a target function turned on;
the apparatus further includes:
a receiving module configured to, in response to that the second electronic device has turned on the target function, receive the first packet sent by the first electronic device through the target function.

In one embodiment of the present disclosure, the apparatus further includes:
a power supply module configured to supply power to a random access memory, a microcontroller unit, an Ethernet unit and a wireless overlay network unit of the second electronic device to support the second electronic device to receive the first packet sent by the first electronic device through the target function.

In one embodiment of the present disclosure, the apparatus further includes:
a setting module configured to, in response to a mode setting operation on the second electronic device, set the second electronic device to a low-power screen projection mode to enable the second electronic device to start up in the screen-off state in the low-power screen projection mode.

In one embodiment of the present disclosure, the first electronic device is installed with a target application, and the second electronic device is configured with a target function;
the apparatus further includes:
a pairing module configured to share the MAC address of the second electronic device with the first electronic device installed with the target application through the target function of the second electronic device, so that the first electronic device is paired with the second electronic device.

In one embodiment of the present disclosure, the apparatus further includes:
an adjustment module configured to, in response to receiving a play adjustment instruction sent by the first electronic device, adjust content being played on the screen.

The implementations of the functionalities and actions of the respective modules have been described in detail in the implementations of the corresponding steps in the above methods, and will not be elaborated herein.

For the apparatus embodiment, since it basically corresponds to the method embodiment, the relevant part may refer to the part of the description of the method embodiment. The apparatus embodiments described above are merely illustrative, where the units described as separate components may or may not be physically separated, and the components displayed as units may or may not be physical units. That is, they may be located in one place or may be distributed to a plurality of network units. Some or all of the modules may be selected according to actual needs, to achieve the objectives of the solutions of the present disclosure.

The present disclosure also provides an electronic device. Referring to FIG. 13, FIG. 13 is a schematic structural diagram illustrating an electronic device according to an embodiment of the present disclosure. As shown in FIG. 13, the electronic device includes a processor 1310, a memory 1320 and a network interface 1330. The memory 1320 is used for storing computer program codes that can be run on the processor 1310, the processor 1310 is used for implementing the operations performed by the first electronic device in the screen projection control method provided by any embodiment of the present disclosure when the computer program codes are executed, and the network interface 1330 is used for implementing input and output functions. In more possible implementation methods, the electronic device may also include other hardware, and the present disclosure is not limited to this.

The present disclosure also provides a computer readable storage medium, the computer readable storage medium can be in various forms. For example, in different examples, the computer readable storage medium can be: a random access memory (RAM), a volatile memory, a non-volatile memory, a flash memory, a storage driver (such as a hard disk drive), a solid state disk, any type of memory disk (such as an optical disc and a digital video disk (DVD)), or a similar storage medium, or a combination thereof. In particular, the computer readable storage medium can also be paper or other suitable medium on which programs are printed. A computer program is stored on the computer readable storage medium, and when the computer program is executed by a processor, the processor is configured to implement the operations performed by the first electronic device in the screen projection control method provided by any embodiment of the present disclosure.

The present disclosure also provides a computer program product, including a computer program, when the computer program is executed by a processor, the processor is configured to implement the operations performed by the first electronic device in the screen projection control method provided by any embodiment of the present disclosure.

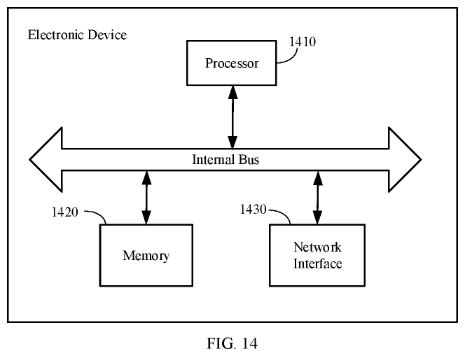

The present disclosure also provides another electronic device. Referring to FIG. 14, FIG. 14 is a schematic structural diagram illustrating an electronic device according to an embodiment of the present disclosure. As shown in FIG. 14, the electronic device includes a processor 1410, a memory 1420 and a network interface 1430. The memory 1420 is used for storing computer program codes that can be run on the processor 1410, the processor 1410 is used for implementing the operations performed by the second electronic device in the screen projection control method provided by any embodiment of the present disclosure when the computer program codes are executed, and the network interface 1430 is used for implementing input and output functions. In more possible implementation methods, the electronic device may also include other hardware, and the present disclosure is not limited to this.

The present disclosure also provides another computer readable storage medium, the computer readable storage medium can be in various forms. For example, in different examples, the computer readable storage medium can be: a random access memory (RAM), a volatile memory, a non-volatile memory, a flash memory, a storage driver (such as a hard disk drive), a solid state disk, any type of memory disk (such as an optical disc and a digital video disk (DVD)), or a similar storage medium, or a combination thereof. In particular, the computer readable storage medium can also be paper or other suitable medium on which programs are printed. A computer program is stored on the computer readable storage medium, and when the computer program is executed by a processor, the processor is configured to implement the operations performed by the second electronic device in the screen projection control method provided by any embodiment of the present disclosure.

The present disclosure also provides another computer program product, including a computer program, when the computer program is executed by a processor, the processor is configured to implement the operations performed by the second electronic device in the screen projection control method provided by any embodiment of the present disclosure.

In the present disclosure, the terms “first” and “second” are only used for descriptive purposes, which cannot be understood as indicating or implying relative importance. The term “a plurality of” refers to two or more than two, unless otherwise specifically defined.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and embodiments are exemplary only, with a true scope and spirit of the present disclosure being indicated by the following claims.

It should be understood that the present disclosure is not limited to the above described structures shown in the drawings, and various modifications and changes can be made to the present disclosure without departing from the scope thereof. The scope of the present disclosure is to be limited only by the appended claims. Those skilled in the art can understand and implement the present disclosure without creative labor.

1. A screen projection control method, being applicable to a first electronic device, wherein the first electronic device has been paired with one or more second electronic devices;
the method comprises:
in response to detecting a setting operation, sending a first packet to the second electronic devices that have been paired, wherein the first packet is configured to control the second electronic devices to start up in a screen-off state; and
when the second electronic devices are in a start-up state, in response to receiving a screen projection instruction, sending screen projection data to the second electronic devices to enable the second electronic devices to enter a screen-on state after receiving the screen projection data and display the received screen projection data.

2. The method according to claim 1, wherein in response to detecting the setting operation, sending the first packet to the second electronic devices that have been paired comprises:
in response to detecting the setting operation, sending the first packet to a plurality of second electronic devices that have been paired and located within a setting range through broadcast.

3. The method according to claim 2, wherein the first packet at least comprises a media access control (MAC) address of the plurality of second electronic devices, so that the plurality of second electronic devices perform verification based on the MAC address comprised in the received first packet, and perform a process of starting up in the screen-off state in response to that the MAC address passes the verification.

4. The method according to claim 1, wherein the setting operation comprises at least one of:
a position of the first electronic device changes; or
an operation event of a setting type occurs in a setting application in the first electronic device.

5. The method according to claim 3, wherein the first electronic device is installed with a target application, and the second electronic devices are configured with a target function;
a process of pairing the first electronic device with the second electronic devices comprises:
obtaining the MAC address of the second electronic devices configured with the target function through the target application in the first electronic device and storing the obtained MAC address, so that the first electronic device is paired with the second electronic devices.

6. The method according to claim 1, wherein after when the second electronic devices are in the start-up state, in response to receiving the screen projection instruction, sending screen projection data to the second electronic devices, the method further comprises:
in response to detecting a play adjustment operation, sending a play adjustment instruction to the second electronic devices, wherein the play adjustment instruction is configured to control the second electronic devices to adjust content being played on a screen.

7. A screen projection control method, being applicable to a second electronic device, wherein the second electronic device has been paired with a first electronic device;
the method comprises:
in response to receiving a first packet sent by the first electronic device that has been paired, starting up in a screen-off state; and
in response to receiving screen projection data sent by the first electronic device, controlling the second electronic device to enter a screen-on state and displaying the received screen projection data on a screen.

8. The method according to claim 7, wherein the first packet at least comprises a media access control (MAC) address of the second electronic device;
in response to receiving the first packet sent by the first electronic device that has been paired, starting up in the screen-off state comprises:
in response to receiving the first packet, performing verification on the MAC address comprised in the first packet; and
in response to that the MAC address passes the verification, starting up in the screen-off state.

9. The method according to claim 7, wherein starting up in the screen-off state comprises:
in the screen-off state, supplying power to a central processing unit (CPU), a logic circuit and an embedded multi media card (eMMC) of the second electronic device to enable the second electronic device to monitor the screen projection data through the CPU, the logic circuit and the eMMC.

10. The method according to claim 7, wherein the second electronic device is configured in advance to have a target function turned on;
before in response to receiving the first packet sent by the first electronic device that has been paired, starting up in the screen-off state, the method further comprises:
in response to that the second electronic device has turned on the target function, receiving the first packet sent by the first electronic device through the target function.

11. The method according to claim 10, wherein before starting up in the screen-off state, the method further comprises:
supplying power to a random access memory, a microcontroller unit, an Ethernet unit and a wireless overlay network unit of the second electronic device to support the second electronic device to receive the first packet sent by the first electronic device through the target function.

12. The method according to claim 7, wherein before in response to receiving the first packet sent by the first electronic device that has been paired, starting up in the screen-off state, the method further comprises:
in response to a mode setting operation on the second electronic device, setting the second electronic device to a low-power screen projection mode to enable the second electronic device to start up in the screen-off state in the low-power screen projection mode.

13. The method according to claim 7, wherein the first electronic device is installed with a target application, and the second electronic device is configured with a target function;
a process of pairing the first electronic device with the second electronic device comprises:
sharing the MAC address of the second electronic device with the first electronic device installed with the target application through the target function of the second electronic device, so that the first electronic device is paired with the second electronic device.

14. The method according to claim 7, wherein after in response to receiving screen projection data sent by the first electronic device, controlling the second electronic device to enter the screen-on state and displaying the received screen projection data on the screen, the method further comprises:
in response to receiving a play adjustment instruction sent by the first electronic device, adjusting content being played on the screen.

15. (canceled).

16. (canceled).

17. An electronic device, comprising a memory, a processor and a computer program stored in the memory and executable by the processor the processor, wherein, when the computer program is executed by the processor, the following methods are implemented:
in response to detecting a setting operation, send a first packet to one or more second electronic devices that have been paired with a first electronic device, wherein the first packet is configured to control the second electronic devices to start up in a screen-off state; and
when the second electronic devices are in a start-up state, in response to receiving a screen projection instruction, send screen projection data to the second electronic devices to enable the second electronic devices to enter a screen-on state after receiving the screen projection data and display the received screen projection data.

18. An electronic device, comprising a memory, a processor and a computer program stored in the memory and executable by the processor the processor, wherein, when the computer program is executed by the processor, the processor is configured to implement the operations performed by the screen projection control method according to claim 7.

19. A computer readable storage medium storing a program thereon, wherein, when the program is executed by a processor, the processor is configured to implement the operations performed by the screen projection control method according to claim 1.

20. A computer readable storage medium storing a program thereon, wherein, when the program is executed by a processor, the processor is configured to implement the operations performed by the screen projection control method according to claim 7.
